SEQUENCE LISTING (17 sequences)

SEQ ID NO: 1 - DNA, 22 bp, mouse
tgcgataaagttttatttttat

SEQ ID NO: 2 - DNA, 26 bp, mouse
gttgtgtttcgttttgtttttttttt

SEQ ID NO: 3 - DNA, 30 bp, mouse
gtaaagtgattggttttgtatttttaagtg

SEQ ID NO: 4 - DNA, 29 bp, mouse
ttaattactctcctacaactttccaaatt

SEQ ID NO: 5 - DNA, 12 bp, mouse
tataggcgtttt

SEQ ID NO: 6 - DNA, 12 bp, mouse
tttatgcgttat

SEQ ID NO: 7 - DNA, 12 bp, mouse
tataggcgtttt

SEQ ID NO: 8 - DNA, 12 bp, mouse
tttatgcgttat

SEQ ID NO: 9 - DNA, 12 bp, mouse
tataggcgtttt

SEQ ID NO: 10 - DNA, 79 bp, human
aatatttataggtgttttatgcgttataaaatatttataggtgttttatgcgttataaaatatttataggtgttttatg

SEQ ID NO: 11 - DNA, 16 bp, human
aatccactaaaaaccc

SEQ ID NO: 12 - DNA, 12 bp, human
tgggttcgttcg

SEQ ID NO: 13 - DNA, 12 bp, human
ttcgttcggagt

SEQ ID NO: 14 - DNA, 12 bp, human
cgttgtcggggt

SEQ ID NO: 15 - DNA, 12 bp, human
ttaggtcgggtt

SEQ ID NO: 16 - DNA, 55 bp, human TERT
  misc_feature (22)..(22): n is a, c, g, or t
atttttgggttcgttcggagtngttgcgttgtcggggttaggtcgggtttttagt

SEQ ID NO: 17 - DNA, 79 bp, mouse; identical to SEQ ID NO: 10

(19) United States
(12) Patent Application Publication
(10) Pub. No.: US 2011/0238318 A1
(43) Pub. Date: Sep. 29, 2011

(54) Simple algorithm for quantifying polymorphisms in electropherograms

(76) Inventor: Craig A. Cooney, Little Rock, AR (US)

(21) Appl. No.: 12/387,597

(22) Filed: May 5, 2009

Related U.S. Application Data
(60) Provisional application No. 61/126,443, filed on May 5, 2008.

(51) Int. Cl. G06F 19/10

(52) U.S. Cl. 702/19

(57) ABSTRACT

A method for quantifying cytosine methylation at a particular target CpG site in DNA of a cell or organism, by performing bisulfite genomic sequencing, wherein a DNA sample extracted from a cell or organism is treated with sodium bisulfite to convert cytosine to uracil and a selected fragment of this treated DNA is amplified, performing a sequence analysis of the amplificate from an electropherogram wherein the area under a peak is measured in a plurality of peaks at either side of the target CpG site to determine the mean T area (T bar) surrounding the site, subtracting the area of the T at the target CpG site from the mean T area wherein the difference is termed delta T, and calculating the proportional level of methylation as a quotient of delta T/T bar, or as a percent value, is presented.

This application is related to U.S. provisional patent application Ser. No. 61/126,443, filed May 5, 2008, from which priority is claimed under 35 U.S.C. §119(e)(1) and which is incorporated herein by reference in its entirety.

This invention was made with government support under P01AG20641 awarded by National Institute on Aging/National Institutes of Health and R01AA016676 awarded by National Institute on Alcohol Abuse and Alcoholism/National Institutes of Health. The government has certain rights in the invention. Additional support was provided by Arkansas Biosciences Institute (Arkansas Tobacco Settlement Fund).

### BACKGROUND OF THE INVENTION

1. Field of the Invention

The present invention generally concerns a method for quantifying a polymorphism or site-specific DNA methylation in a single cell, a virus, a multicellular organism, or a population of viruses, cells or organisms.

Moreover, the present invention more specifically concerns a process to quantify the amount of a nucleotide signal in a sequencing electropherogram. This method is particularly useful to quantify signals of bases that are unusual in the sequence and for which there are few (or no) examples in the sequence to use as internal standards. An example of this is the widely used bisulfite genomic sequencing method where cytosine peaks are underrepresented. The method and process accurately quantifies a thymine peak comigrating with a cytosine peak.

The present invention particularly concerns an improved bisulfite genomic sequencing (BGS) analysis method that quantifies methylation at any particular site by subtracting the thymine signal at that site from the average signal of 10 surrounding thymine peaks. Inventor calls this method “Mquant.”

2. Description of Related Art

This invention revolves around the pressure applied to the genome of an organism by environmental forces. This pressure is believed to act upon and drive the stoic hereditary genome defined by the DNA sequence, and is known as epigenetics.

First introduced by Conrad Waddington in 1942, the term “epigenetics” was used to describe “the branch of biology which studies the causal interactions of genes with their environment, which bring the phenotype into being” (1). However, conceptual origins of epigenetics date back to Aristotle. The field of epigenetics has emerged to bridge the gap between nature and nurture.

Epigenetics refers to modifications to DNA and chromatin that persist from one cell division to the next regardless of a lack of change in the underlying DNA sequence. Transgenerational inheritance is shown by some epigenetic changes, indicating that these changes can be passed from one generation to the next. Epigenetics is involved in cellular differentiation, allowing distinct cell types to have specific characteristics even as they share the same DNA sequence. Imprinting, bookmarking, gene splicing, paramutation, X chromosome inactivation, reprogramming, position effect, histone modifications and heterochromatin, some carcinogenesis, maternal effects, and transvection are some examples of epigenetic processes. The epigenome refers to the overall epigenetic state of a cell while the epigenetic code refers to epigenetic features such as DNA methylation and histone modifications that create different phenotypes in different cells.

Epigenetic inheritance systems mechanics are still incompletely understood, but our current understanding has uncovered at least 4 mechanisms by which epigenetic changes persist over time. These include RNA transcripts, cellular structures, DNA methylation/chromatin remodeling, and even prions.

Methylation, on a DNA level, is the addition of a methyl group to a cytosine residue to convert it to 5-methylcytosine. Methylation of DNA occurs at CpG sites, where cytosine (C) lies next to guanine (G). The CpG sites are in regions near the promoters of genes. These regions are known as CpG islands. The state of methylation of CpG islands is critical to both gene activity and gene expression.

Identification and characterization of DNA methylation came later in 1948 (2). This was the first epigenetic mark to be discovered. Cytosine is the predominant target for DNA methylation in the mammalian genome. An enzymatic attachment of a methyl group to the 5 position of the pyrimidine ring produces 5-methylcytosine (3), which has sometimes been referred to as the fifth base of genomic DNA.

Methylation adds four atoms to cytosine, one of the four DNA bases. Cytosine is also part of deoxycytidine which is one of the four DNA nucleosides. The body naturally uses methylation to turn genes on and off. The additional atoms block the proteins that transcribe genes. But, when something goes awry, methylation can unleash a tumor by silencing a gene that normally keeps cell growth in check. Removing a gene's natural methylation can also render a cell cancerous by activating a gene that is typically “off” in a particular tissue.

Although by some methods and for some biological functions 5-methylcytosine is indistinguishable from cytosine within the structure of the DNA molecule, where both base-pair with guanine, the presence of the methyl group has considerable biological implications for DNA function (4). Alterations in DNA methylation affecting target sequences within the transcriptional control regions of genes produce changes in gene expression, with hypomethylation leading to increased expression and hypermethylation leading to decreased expression. In contemporary terms, epigenetics refers to modifications of the genome that are heritable during cell division but do not involve a change in the DNA sequence (4). Thus, epigenetics describes heritable changes in gene expression that are not simply attributable to nucleotide sequence variation (5). It is now recognized that epigenetic regulation of gene expression reflects contributions from both DNA methylation and complex modifications of histone proteins and chromatin structure (6). Nonetheless, DNA methylation plays a central role in nongenomic inheritance and in the preservation of epigenetic states, and remains the most accessible epigenomic feature because of its inherent stability (4). Thus, DNA methylation represents a target of fundamental importance in the characterization of the epigenome, in defining the role of epigenetics in disease pathogenesis, and in the development of useful molecular tools for diagnostic testing and prediction of prognosis in neoplastic and non-neoplastic diseases (7-9). Ogino et al (10) investigated one such molecular tool, sodium bisulfite conversion of DNA followed by MethyLight real-time polymerase chain reaction (PCR), and described the factors that influence the variability of quantitative analysis. However, to fully understand these results, it is important to comprehend the importance of DNA methylation in cancer and the significance of such information to cancer diagnosis and prognosis.

Sequencing the human genome was far from the last step in explaining human genetics. Researchers still need to figure out which of the 20,000-plus human genes are active in any one cell at a given moment. Chemical modifications can interfere with the machinery of protein manufacture, shutting genes down directly or making chromosomes hard to unwind. Such chemical interactions constitute a second order of genetics, i.e., epigenetics.

Methylation of cytosines in DNA is an epigenetic modification in vertebrates, higher plants and some other eukaryotes. It is strongly associated with gene silencing, and its gene- and site-specific quantification is important to understand epigenetic changes in biology including in development, behavior, cancer and aging (11-18).

Site-specific DNA methylation can be quantified by numerous methods, most of which use restriction digestion and/or bisulfite treatment (19-23). However, there are difficulties and/or disadvantages associated with the methods described heretofore. Some of these methods are limited to just one or a few sites. Several methods use genomic sequencing to quantify methylation over stretches of DNA up to a few hundred nucleotides. Each of these methods require specialized techniques and/or equipment not widely used or widely available (20, 23, 26, 28, 29). Bisulfite genomic sequencing (BGS) and related bisulfite based techniques (19, 34) are among the most useful methods to detect DNA methylation. Capillary electrophoresis methods producing four-dye-trace electropherograms are widely used to detect methylation with BGS. But, this method is not quantitative without subcloning, sequencing and averaging each sample (35-37) or without use of complex, specialized algorithms (26). Recently, Dikow et al. (22) described a simple way to quantify DNA methylation from BGS four-dye-trace electropherograms, but they show the maximum mean signal generated to be just over 80% methylation (that is known not to be the case), and they suggest that quantification by bisulfite treatment may be intrinsically problematic. They presented data showing that a specialized, nonbisulfite technique (22, 27) was more accurate approach.

In addition to DNA methylation and epigenetics, important variations occur in nucleic acid sequences themselves. These variations, often called polymorphisms, affect the coding, activity, splicing etc. of nucleic acids including DNA and RNA. Polymorphisms can be measured in populations of animals, plants and viruses, and are often studied to understand why some individuals or populations have certain phenotypes or have certain characteristics to a different degree than other individuals or populations.

Citation of any document herein is not intended as an admission that such document is pertinent prior art, or considered material to the patentability of any claim of the present application. Any statement as to content or a date of any document is based on the information available to applicant at the time of filing and does not constitute an admission as to the correctness of such a statement.

### SUMMARY OF THE INVENTION

The primary object of this invention is to provide an uncomplicated, cost-effective and accurate method for quantifying the levels of cytosine methylation in genomic DNA.

Another object in accordance with the present invention is to provide a method to quantify methylation on multiple independent CpG sites from analysis of a single sequencing run.

Yet, another and highly preferred object is a method that works well over the entire range of methylation levels, making it suitable for analyses of hypo- and hypermethylation and of methylation associated with imprinting.

Still, another highly preferred object of this invention is to define a quantification method that is amenable to robotic or manual high throughput methods, such as, for example, would be suitable for screening for deleterious effects, diagnosis, treatment modalities and prognosis of cancer.

Yet another preferred object is to quantify polymorphisms that occur in nucleic acid sequences themselves (without any bisulfite treatment). A particularly preferred object is to quantify polymorphisms where few or no other examples of one of the polymorphic nucleosides, nucleotides or bases exist in the sequence.

A further, most preferred object is to provide a method that uses less than the DNA needed for other, known, analysis methods, making it more suitable for determining methylation or polymorphisms in extremely small samples, for example, paraffin sections, and so forth. Other uses will become apparent to one familiar with the art.

In accordance with these objects, this invention contemplates a preferred method to quantify cytosine methylation at a particular target CpG site in DNA of a virus, cell or organism. The method involves performing bisulfite genomic sequencing, wherein a DNA sample extracted from a virus, cell or organism is treated with sodium bisulfite to convert cytosine to uracil, and a selected fragment of this treated DNA is amplified. 5-methylcytosine is unaffected by the bisulfite treatment. The treated DNA fragment is then amplified by PCR (a term known to those familiar with the art).

The contemplated method further involves performing a sequence analysis of the PCR amplificate from an electropherogram, wherein the area under a peak is measured in a plurality of peaks at either side of the target CpG site to determine the mean T area (T bar) surrounding the site. The method further contemplates subtracting the area of the T at the target CpG site from the mean T area. The difference obtained is termed delta T, and the proportional level of methylation is calculated as a quotient of delta T/T bar.

A more specific and preferred embodiment of this invention is an improved method, extending a known method to quantify DNA methylation at a particular site from bisulfite genomic sequencing using data from four-dye-trace value electropherograms from fluorescent dye terminator sequencing.

The improvement of the known method involves selecting a target CpG site and determining the mean T area (T bar) from a plurality of Ts surrounding the target CpG site. Also involved in this improvement are the steps of subtracting the area of the T at the target CpG site from T bar, wherein the subtracting yields delta T, and calculating the level of methylation on the site as the proportion of (delta T)/(T bar). The Ts surrounding the target CpG site may number 2-20. However, the preferred number of Ts surrounding the target CpG site is 10 or more. The Ts used to calculate T bar preferably have a T signal-to-noise ratio of 10 or better with respect to their secondary peak, and are at least 10 times the area of their secondary base (C, G or A). Preferably, an equal number of T's from each side of the target CpG are used, and preferably the number comprises 5 on each side. The calculation may be stated as 100×(delta T)/(T bar), representing the percentage of methylation.

A most preferred embodiment in accordance with this invention is an algorithm for quantifying DNA methylation at a particular site from bisulfite genomic sequencing, using data from four-dye-trace trace value electropherograms from fluorescent dye terminator sequencing. The algorithm involves choosing the target CpG site, determining the mean T area (T bar) from 10 Ts surrounding the target CpG site provided that Ts used to calculate T bar are at least 10 times the area of their secondary base (C, G or A), the Ts used to calculate T bar have a T signal-to-noise ratio of 10 or better with respect to their secondary peak, and an equal number of T's from each side of the target CpG (i.e. 5 on each side) are used. The algorithm further requires subtracting the area of the T at the target CpG site from T bar to yield delta T (i.e. T bar−CpG T=delta T), and calculating the level of methylation on the site as the proportion, (delta T)/(T bar), or the percentage, 100×(delta T)/(T bar).

When there are not 10 peaks in close proximity to the specific CpG site, any number from 2-20 can be used for calculation without seriously affecting the calculation; however, 10 (5 flanking each side) are preferred. In some embodiments the 2-20 closest peaks (not necessarily symmetrical and not necessarily the same number on each side) can be used for calculation without seriously affecting the calculation; however, 10 (5 flanking each side) are preferred.

Another preferred embodiment uses a generalized form of the algorithm for quantifying a base, nucleoside or nucleotide at a particular polymorphic site from electropherogram trace values. The algorithm involves choosing the target polymorphic site and a nucleotide N1, to be quantified, and a second polymorphic nucleotide at the polymorphic site (N2p), and determining the mean N2 area (N2 bar) from 10 N2 nucleotides surrounding the target polymorphic site using an equal number of N2s from each side of the target polymorphic site (i.e. 5 on each side). The algorithm further requires subtracting the area of the N2 at the target polymorphic site (N2p) from N2 bar to yield delta N2 (i.e. N2 bar−N2p=delta N2), and calculating the level of N1 on the polymorphic site as the proportion, (delta N2)/(N2 bar), or the percentage, 100×(delta N2)/(N2 bar).

A more preferred embodiment of the generalized form of the algorithm uses 10 N2 nucleotides to determine the mean N2 area (N2 bar) that are at least 10 times the area of their secondary nucleotide (base) such that the N2s used to calculate N2 bar have an N2 signal-to-noise ratio of 10 or better with respect to their secondary peak. In some embodiments the 2-20 closest N2 peaks (not necessarily symmetrical and not necessarily the same number on each side) can be used for calculation without seriously affecting the calculation; however, 10 (5 flanking each side) N2 peaks are preferred.

Still further embodiments and advantages of the invention will become apparent to those skilled in the art upon reading the entire disclosure contained herein.

### BRIEF DESCRIPTION OF THE DRAWINGS

FIG. 1 shows a gel electrophoresis run for quantification of DNA methylation by COBRA (32, 33), a scan of this gel and a corresponding electropherogram from the same amplificate analyzed by Mquant. A) A bisulfite PCR product was digested with HpyCH4IV (ACGT) to give three bands of 372, 248 and 124 bp. The 372 bp band is undigested DNA (representing unmethylated DNA that now has an ATGT site). The smaller bands represent methylated DNA whose single HpyCH4IV site was cleaved. The digested DNA lane is marked Hpy and the undigested DNA lane is marked U. B) A scan of the digested lane of this gel. C) The peak areas of the 372 and 248 bp bands from four determinations were quantified and their relative peak areas are shown (with 372 bp areas normalized to 100). D) The T trace of the electropherogram was analyzed by Mquant as described in the text. E) The relative copy numbers of the 372 and 248 bp bands were used to calculate the percent DNA methylation (5MC) of the original DNA. The percent methylation by Mquant is also shown. Analyses of this individual PCR amplificate gave a mean percent methylation (+/−SD) by COBRA of 34.6+/−5.2% with a CV of 15% (n=4) and a mean percent methylation by Mquant of 38.4+/−6.8 with a CV of 18% (n=4). The differences in the two methods for this amplificate are not statistically significant (p=0.40) and are <4% methylation (35 versus 38%).

FIG. 2a is a plot of the percent DNA methylation on the CpG of an ACGT site from 19 different DNA samples determined by COBRA versus the percent methylation on this same site determined by peak areas on forward sequence electropherograms. The results of the two methods were highly correlated (R=0.95, P<10-09) and in good agreement (estimate±standard error=0.98±0.079 for slope, and 0.012±0.031 for y-intercept). The average percent methylation measured by COBRA and Mquant were both 32%.

FIG. 2b shows A Bland-Altman plot of the data shown in FIG. 2a. The vertical axis shows the difference in methylation values measured by the two methods (Mquant minus COBRA), whereas the horizontal axis shows the average methylation value measured by the two. The mean (SD) of the difference between methods was +0.72% (7.6%), indicating little evidence of bias between the methods (P=0.68). The center dashed horizontal line shows the mean difference, while the outside horizontal lines show the 95% LoA's (at −14.4%, +15.9%).

FIG. 3 demonstrates gel electrophoresis for quantification of DNA methylation by COBRA, a scan of this gel, and a corresponding electropherogram from the same amplificate analyzed by Mquant. A) A bisulfite PCR product was digested with Taqalphal (TCGA) to give three bands of 307, 190 and 117 bp. The 307 bp band is undigested DNA (representing unmethylated DNA that now has a TTGA site). The smaller bands represent methylated DNA whose single Taqalphal site was cleaved. The peak areas of the 307 and 190 bp bands were quantified and their relative copy numbers were calculated and used to calculate the percent methylation of the original DNA. The digested DNA lane is marked Taq and the undigested DNA lane is marked U. B) A scan of the digested lane of this gel. C) The peak areas of the 307 and 190 bp bands from five determinations were quantified and their relative peak areas are shown (with 307 bp areas normalized to 100). D) The T trace of the electropherogram was analyzed by Mquant as described in the text. E) The relative copy numbers of the 307 and 190 bp bands were used to calculate the percent DNA methylation of the original DNA. The percent methylation by Mquant is also shown. Analyses of this individual PCR amplificate gave a mean percent methylation (+/−SD) by COBRA of 95.7+/−2.1 with a CV of 2.2% (n=5) and a mean percent methylation by Mquant of 91.7+/−1.0 with a CV of 1.1% (n=5). The differences in the two methods for this amplificate are statistically significant (p<0.01, marked with an asterisk in E)) but differ by only 4% methylation (96 versus 92%). The standard deviation (shown as error bars) is large in C) because it includes the variation (2.1%) in the percent of unmethylated site (4.3%).

FIG. 4a is a plot of the percent DNA methylation on the CpG of a TCGA site from 29 different DNA samples determined by COBRA versus the percent methylation on this same site determined by peak areas on forward sequence electropherograms. The results of the two methods are highly correlated (R=0.91, P=7.0×10-12), but in rather poor agreement (estimate±standard error=0.84±0.073 for the slope, and 0.009±0.048 for the y-intercept). The average percent methylation measured by COBRA and Mquant were 61% and 52% respectively.

FIG. 4b shows a Bland-Altman plot of the data shown in FIG. 4a. The vertical axis shows the difference in methylation values measured by the two methods (Mquant minus COBRA), whereas the horizontal axis shows the average methylation value measured by the two. The mean (SD) of the difference between methods was −8.9% (10.3%), indicating statistically significant evidence (P<0.0001) of a bias toward lower values as measured by Mquant compared to COBRA. The center dashed horizontal line shows the mean difference, while the outside horizontal lines show the 95% LoA's (at −29.5%, +11.7%).

FIG. 5 shows gel electrophoresis for quantification of DNA methylation by COBRA, a scan of this gel, and a corresponding electropherogram from the same amplificate analyzed by Mquant. A) A bisulfite PCR product was digested with Acil (GCGG) to give three bands of 372, 242 and 130 bp. The 372 bp band is undigested DNA (representing unmethylated DNA that now has a GTGG site). The smaller bands represent methylated DNA whose single Acil site was cleaved. The peak areas of the 372 and 242 bp bands were quantified and their relative copy numbers were calculated and used to calculate the percent methylation of the original DNA. The digested DNA lane is marked Aci and the undigested DNA lane is marked U. B) A scan of the digested lane of this gel. C) The peak areas of the 372 and 242 bp bands from four determinations were quantified and their relative peak areas are shown (with 372 bp areas normalized to 100). D) The T trace of the electropherogram was analyzed by Mquant as described in the text. E) The relative copy numbers of the 372 and 242 bp bands were used to calculate the percent DNA methylation of the original DNA. The percent methylation by Mquant is also shown. Analyses of this individual PCR amplificate gave a mean percent methylation (+/−SD) by COBRA of 82.0+/−1.0 with a CV of 1.2% (n=4) and a mean percent methylation by Mquant of 90.9+/−2.5 with a CV of 2.7% (n=4). The differences in the two methods for this amplificate are statistically significant (p<0.003, marked with an asterisk in E)) but only differ by 9% methylation (82 versus 91%).

FIG. 6a is a plot of the percent DNA methylation on the CpG of a GCGG site from 13 different DNA samples determined by COBRA versus the percent methylation on this same site determined by peak areas on forward sequence electropherograms. The results of the two methods are highly correlated (R=0.98, P=2.7×10-9) and in reasonably close agreement (estimate±standard error=1.07±0.062 for the slope, and −0.026±0.044 for the y-intercept). The average percent methylation measured by COBRA and Mquant were 61% and 63% respectively.

FIG. 6b is a Bland-Altman plot of the data shown in FIG. 6a. The vertical axis shows the difference in methylation values measured by the two methods (Mquant minus COBRA), whereas the horizontal axis shows the average methylation value measured by the two. The mean (SD) of the difference between methods was +1.6% (8.1%), indicating little evidence for bias between methods (P=0.48). The center dashed horizontal line shows the mean difference, while the outside horizontal lines show the 95% LoA's (at −14.6%, +17.8%).

FIG. 7 is an example of an electropherogram of bisulfite treated and PCR amplified mouse Peg 10 gene (47). This gene is imprinted and has intermediate levels of methylation on many CpG sites.

FIG. 8 is an example of an electropherogram of bisulfite treated and PCR amplified human telomerase reverse transcriptase gene (TERT) (48). In some cell types the gene has high levels of methylation on multiple CpG sites.

### DESCRIPTION OF THE PREFERRED EMBODIMENTS

### 1. Introduction

Having assigned such key roles to cytosine methylation, it is no wonder that there is a huge interest in developing procedures to analyze DNA methylation, and especially to have the ability to do it rapidly, cost-effectively, accurately, and with great sensitivity. The potential for large scale screening for disease, identifying the causes, stages, prognoses and designing treatment modalities is very inviting. Not surprising then, that there are many different approaches to quantitate DNA methylation (10-18, 47). Leading the charge and popularity, many of these approaches involve bisulfite treatment of DNA.

These new methods have to be validated as to their effectiveness against well-known and respected methods in existence. Provided herein and below are examples of such verification of the new method that is the subject of this invention.

### Materials and Methods

DNA Extraction and In Vitro Methylation

DNA was extracted from mouse tissues using an Epicentre MasterPure DNA purification kit (Epicentre Biotechnologies, Madison, Wis.) according to the manufacturer's recommendations with minor modifications. Inventor added a phenol (Amresco, Solon Ohio) extraction step and a 1-bromo-3-chloropropane (Molecular Research Center, Inc. Cincinnati, Ohio) extraction step just prior to isopropanol precipitation. Purified DNA was washed with tris-EDTA buffer in Montage centrifugal filters (Millipore, Bedford, Mass.). In some cases DNA was methylated in vitro with SssI (CpG) methylase according to the manufacturer's instructions (New England Biolabs Inc, Ipswich, Mass.) except that DNA was washed in a centrifugal filter and reacted a second time (21) to assure complete methylation.

Bisulfite Modification of DNA

DNA was sodium-bisulfite modified with an Epitect Kit (Qiagen, Valencia, Calif.) according to the manufacturer's instructions. For each bisulfate modification Inventor used 300 ng of DNA. Inventor stored bisulfite-treated DNA at −20° C.

PCR

PCR was performed using a Hot Star Taq DNA polymerase kit (Qiagen, Valencia, Calif.). Each 25 ul PCR reaction included 0.65 units of Hot Star Taq polymerase, 0.22 mM Promega dNTP mix (Promega, Madison, Wis.), and 0.8 uM of each primer. The sequences amplified were from the mouse Avy allele of agouti (38) (Genbank AR302985). Bisulfite modified genomic DNA was amplified by nested PCR using two sets of primers for the Avy allele similar to that described by Rakyan et al. (39).

The first PCR reaction was carried out with 10 ng of DNA using the amplification profile: 1 cycle at 80° C. for 1 min, 1 cycle at 94° C. for 1 min; 2 cycles at (95° C. for 1 min, 64° C. for 1 min, 72° C. for 1 min); 2 cycles at (95° C. for 1 min, 63° C. for 1 min, 72° C. for 1 min); 2 cycles at (95° C. for 1 min, 62° C. for 1 min, 72° C. for 1 min); 2 cycles at (95° C. for 1 min, 61° C. for 1 min, 72° C. for 1 min); 40 cycles at (95° C. for 1 min, 60° C. for 1 min, 72° C. for 1 min); 72° C. for 5 min and cooling to 4° C.

The forward primer 5′-TGCGATAAAGTTTTATTTTTAT-3′ (SEQ ID No 1) and reverse primer 5′-GTTGTGTTTCGTTTTGTTTTTTTTTT-3′ (SEQ ID No 2) used for the first reaction were designed using MethPrimer web software (40) (http://www.urogene.org/methprimer/). A second, nested, PCR was then performed on 1 ul of the amplificate using the upstream and downstream Avy primers (372-bp PCR product) or the upstream and internal Avy primers (307-bp PCR product) of Rakyan et al. (39) with the following cycling conditions: 1 cycle at 80° C. for 1 minute, 1 cycle at 94° C. for 1 min; 2 cycles at (95° C. for 1 min, 63° C. for 1 min, 72° C. for 1 min); 2 cycles at (95° C. for 1 min, 62° C. for 1 min, 72° C. for 1 min); 2 cycles at (95° C. for 1 min, 61° C. for 1 min, 72° C. for 1 min); 2 cycles at (95° C. for 1 min, 60° C. for 1 min, 72° C. for 1 min); 40 cycles at (95° C. for 1 min, 59° C. for 1 min, 72° C. for 1 min); 72° C. for 5 min and cooling to 4° C. The PCR products were electrophoresed through a 2% agarose gel, stained with ethidium bromide, and digitally imaged under UV light using a transilluminator, video camera and LabWorks image acquisition and analysis software (Ultra-Violet Products, Upland Calif.).

Bisulfite Genomic Sequencing (BGS)

To eliminate primers and dNTPs, Inventor treated PCR products with exonuclease I (Epicentre, Madison Wis.) and shrimp alkaline phosphatase (Roche, Nutley, N.J.) (41) at 37° C. for 60 min followed by 85° C. for 15 min. Inventor then concentrated and washed these using Montage centrifugal filters (Millipore, Bedford, Mass.) according to the manufacturer's recommendations. The PCR products were sequenced using the nested upstream primer (Avy forward primer) (39) at the UAMS DNA Sequencing Core Facility using a Model 3100 Genetic Analyzer (Applied Biosystems, Foster City, Calif.) and a Big Dye terminator sequencing kit.

Combined Bisulfite Restriction Assay (COBRA)

For COBRA analysis (32, 33) PCR products were digested with 20 units of restriction enzyme Taqalphal (TCGA), HpyCH4IV (ACGT), or Acil (GGCG) (New England Biolabs, Ipswich, Mass.). Each of these enzymes has just one site in the bisulfite-converted sequence when the original genomic sequence was methylated, and no site in the bisulfite-converted sequence when the original genomic sequence was unmethylated. For digestion, a 10-to-20 fold excess of enzyme was used for two hours, but digestion was otherwise according to the manufacturer's instructions. The digested PCR products were separated by gel electrophoresis using 3% GenePure high resolution agarose (ISC BioExpress, Kaysville, Utah) and stained with ethidium bromide. Gels were imaged as described earlier and the images saved as TIFF files.

For COBRA electrophoresis, the amount of digest analyzed was kept low so that the bands were in a gray level (in an approximately linear range) but high enough that they gave a substantial signal. The undigested band and the largest-size digested band were used to quantify methylation because the smaller-size digest bands sometimes did not give a substantial signal. Even at extremes of methylation (near 0 or 100%), at least one band, the undigested or the largest digested band, gave a substantial signal.

Digital images were scanned with Scion Image software (Scion Corporation, Frederick, Md., http://www.scioncorp.com/pages/scion_image_windows.htm) to measure density. Density ratios of a major digested band to the undigested band were used to calculate the relative copy numbers of fragments and subsequently the percent methylation (21, 33).

Peak Area Determination from Sequencing Electropherograms

The ab1 files from sequencing were processed using Phred (42, 43) (http://www.phrap.org/) or BioEdit (http://www.mbio.ncsu.edu/BioEdit/bioedit.html). Sequences were not used if they had substantial artifacts e.g. if more than one T (that had not been a C of a CpG prior to bisulfite) in the region used to quantify methylation showed more than 10% C. The Phred output or BioEdit trace value output were used to read and quantify primary and secondary peaks in the electropherograms. Calculations were performed in Excel (Microsoft, Redmond, Wash.). Peak areas were determined by summing peak trace values. Phred automatically sums the trace values of peaks from baseline (42) and Inventor did the same with trace values from Bioedit after pasting them into Excel spreadsheets. Virtually all baselines between peaks had one or more trace values of zero which allows peak area determination by simple summing of peak trace values.

Algorithm for Quantification of DNA Methylation

DNA methylation levels were quantified from sequencing electropherogram trace values using the following algorithm that Inventor calls “Mquant.”

First, the target CpG site was chosen.

Second, the mean T area (T bar) from 10 Ts surrounding the target CpG site was determined. Is used to calculate T bar were at least 10 times the area of their secondary base (C, G or A). In Inventor's electropherograms, secondary bases were mainly sequencing noise. Thus, the Ts used to calculate T bar had a T signal-to-noise ratio of 10 or better with respect to their secondary peak. An equal number of T's from each side of the target CpG (i.e. 5 on each side) were used.

Third, the area of the T at the target CpG site was subtracted from T bar to yield delta T (i.e. T bar−CpG T=delta T).

Fourth, the level of methylation on the site was calculated as the proportion, (delta T)/(T bar), or the percentage, 100×(delta T)/(T bar).

This algorithm can be generalized such that: in place of the target CpG site, a target polymorphic site is chosen; in place of cytosine, cytidine or deoxycytidine, nucleotide 1 (N1) is used; and in place of thymine, thymidine or deoxythymidine, nucleotide 2 (N2) is used. In place of secondary base (C, G or A), any secondary base (C, G, A, T, U or other) is used. In place of the level or percentage of methylation, the level or percentage of nucleotide 1 (N1) is used.

Data Analysis

Percents methylation by the Mquant and COBRA methods were compared via regression plots using Origin (OriginLab, Northhampton, Mass.) and via Bland-Altman plots using Excel (Microsoft, Redmond, Wash.). Regression was used to calculate slopes, intercepts, and coefficients of correlation between methods, whereas Bland-Altman plots (44, 45) were used to determine means and standard deviations (SDs) of the difference in percents methylation by each method. Bland-Altman 95% Limits of Agreement (95% LoA's) were calculated as the mean±2SDs of the difference in percents methylation by each method, and indicate the limits between which ˜95% of the difference in percents methylation would be expected to fall under a Normal distribution. In some cases Inventor did multiple analyses of single amplificates for which Inventor determined SD, the root mean square error (RMSE) and the coefficient of variation (CV) as measures of run-to-run variation within each experiment.

### Results

The examples as described herein are intended to further illustrate the present invention and are not intended to limit the invention in any way.

Inventor has developed a method to quantify DNA methylation from BGS electropherograms. This method uses and extends previously published methods of sequence analysis (22, 42, 43, 46) so that Inventor can readily quantify the methylation at a particular site using the data from four-dye-trace electropherograms from fluorescent dye terminator sequencing. This allows Inventor to quantify the percent methylation of numerous CpG sites in an electrophoretogram and to validate these levels at specific sites using COBRA assays (33). This method can greatly speed determinations of DNA methylation.

COBRA distinguishes between C and T bases using sequence specific restriction enzymes as measured by the intensities of bands on a gel after DNA fragments are separated by electrophoresis (32, 33). BGS, as used here, distinguishes between C and T bases by different fluorescent dyes on each base at specific positions after separation by capillary electrophoresis. At a target CpG site, T is measured directly and C is measured indirectly as the mean intensity of surrounding Ts minus the intensity of T at the target site (which is shared by C and T).

Inventor used bisulfite PCR amplificates from 45 independent DNA samples containing sites with DNA methylation levels that varied between 0 and 100%. With these, Inventor compared the bisulfite-based techniques of COBRA with a quantitative version of BGS that Inventor calls Mquant. The agouti allele region Inventor used contains 9 CpGs that can be sequenced reliably with the primer sets used. Three of these CpGs are in restriction sites, and were analyzed by both COBRA and Mquant.

A total of 61 COBRA and 61 Mquant determinations were made (from 45 PCR amplificates) to test for agreement between COBRA and Mquant. Each COBRA and corresponding Mquant was performed on the same bisulfite PCR amplificate.

### Example 1

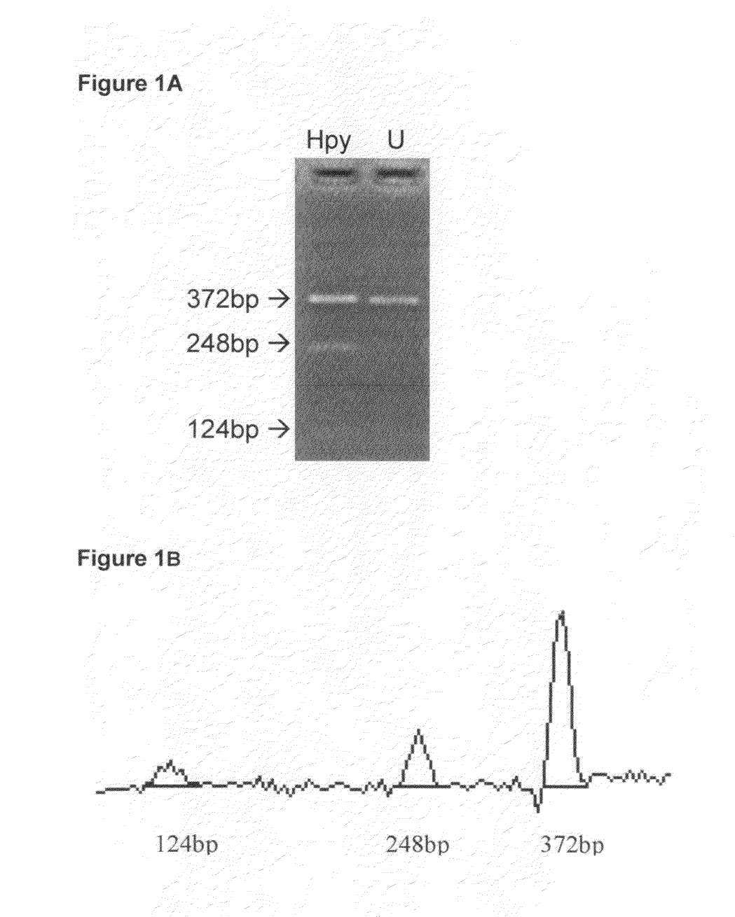

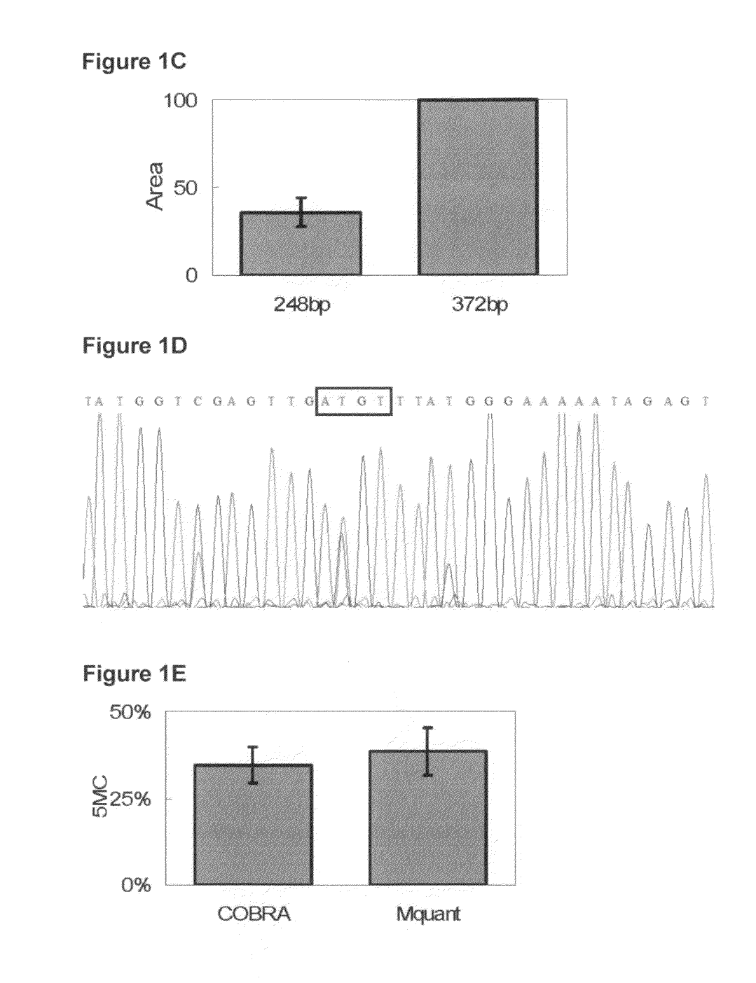

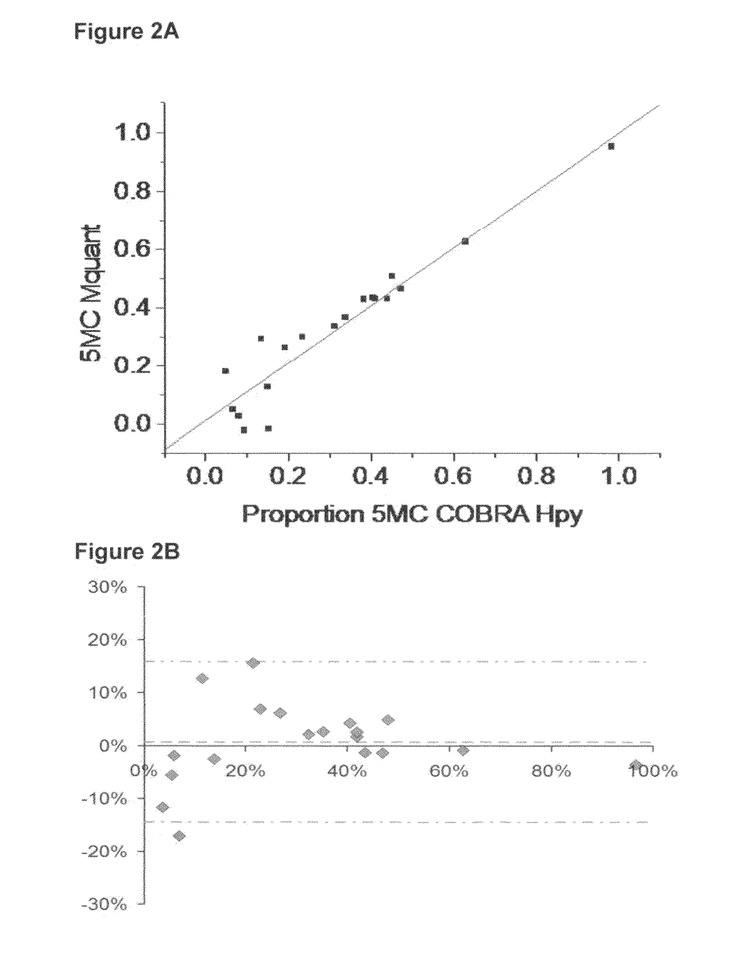

FIG. 1 shows a COBRA gel for measuring methylation of an HpyCH4IV site (ACGT) and the corresponding site in the sequencing electropherogram. In this and other COBRA gels, the amounts of digest loaded were in a moderate range so that the bands were at a gray level (in an approximately linear range) and still gave a substantial signal. FIG. 2A is a regression plot of COBRA values versus electropherogram values at the ACGT site, and shows a high correlation (0.95) between values measured by the two methods. FIG. 2B is a Bland-Altman plot for this same data. The mean (SD) difference between COBRA and Mquant values for the HpyCH4IV site was +0.72% (7.6%), indicating little evidence for bias (P=0.68) between methods. The outside horizontal lines of FIG. 2B show the Bland-Altman 95% LoA's, which are (−14.4%, +15.9%) for the ACGT site. The mean values of percent methylation for COBRA and Mquant were 31.6% and 32.4% respectively. Overall, these results show that the two methods tend to agree well at the HpyCH4IV site.

### Example 2

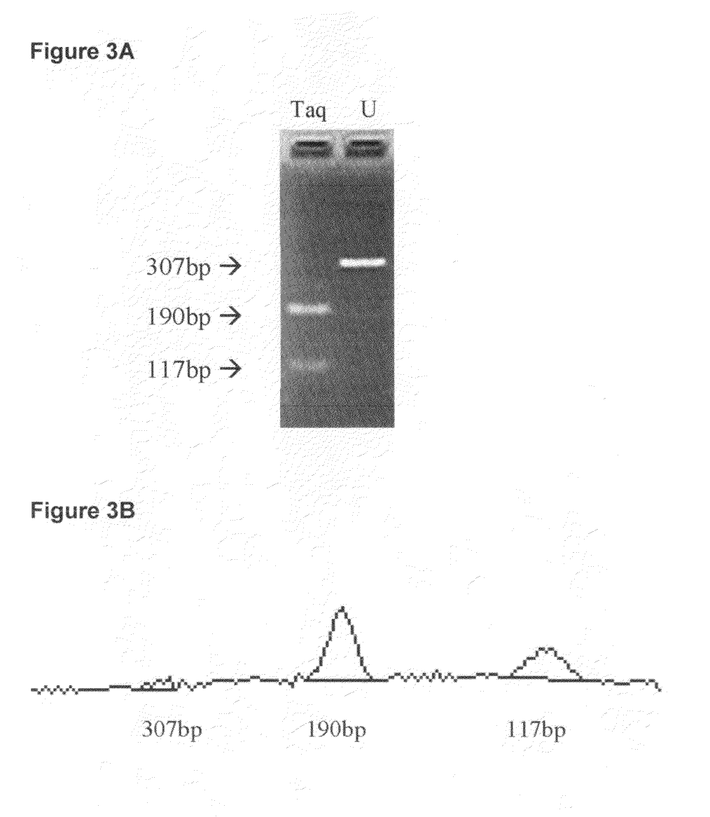

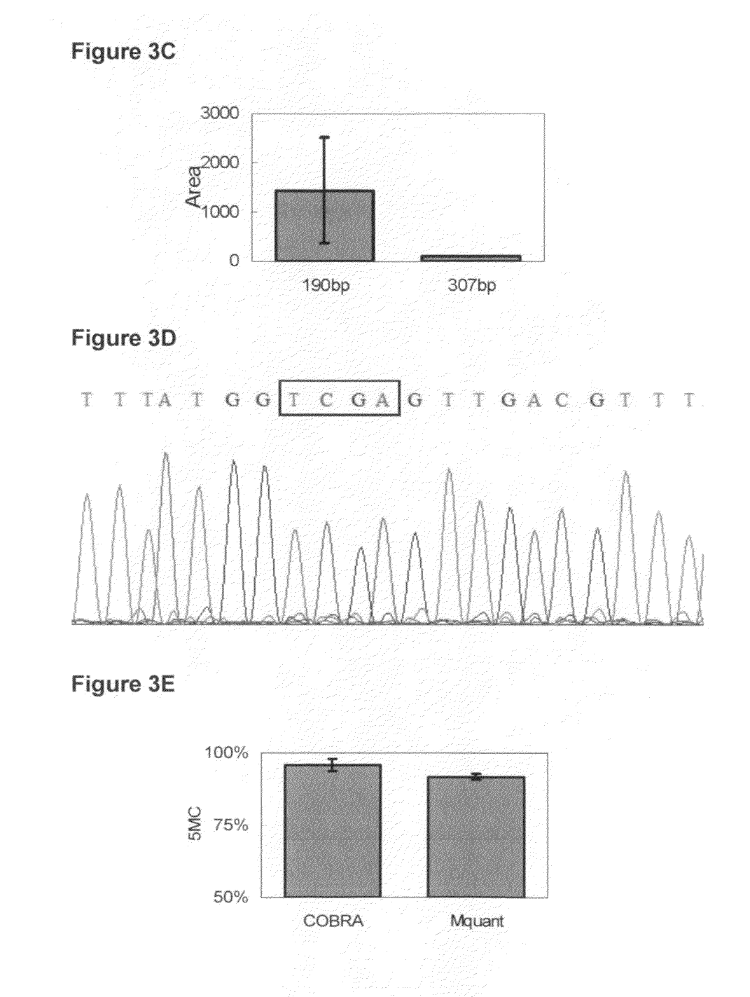

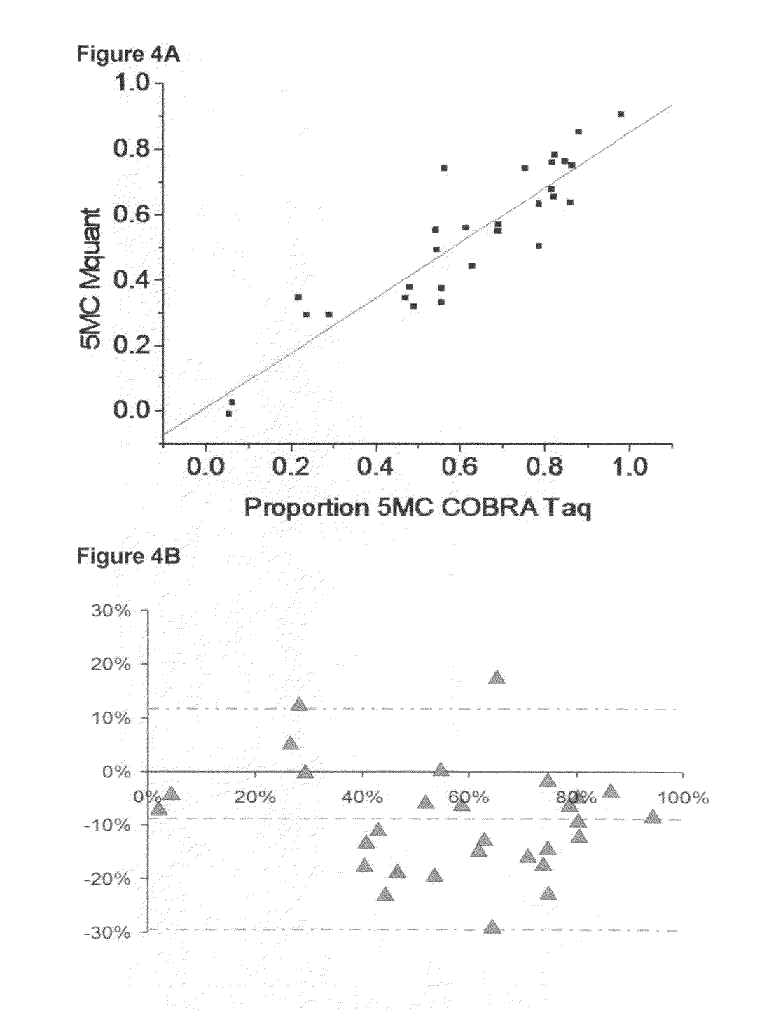

FIGS. 3 through 4B show analogous results for the Taqalphal site (TCGA). The correlation between methylation levels measured by the two methods was somewhat lower (0.91). The mean (SD) difference between values measured by COBRA versus Mquant was −8.9% (10.3%), indicating statistically significant evidence (P<0.0001) of a bias toward lower values as measured by Mquant compared to COBRA. The 95% LoA's were (−29.5%, +11.7%) for the TCGA site. The mean values of percent methylation for COBRA and Mquant were 61% and 52% respectively. Although the bias was statistically significant at the Taqalphal site, it was nevertheless under 10% methylation.

### Example 3

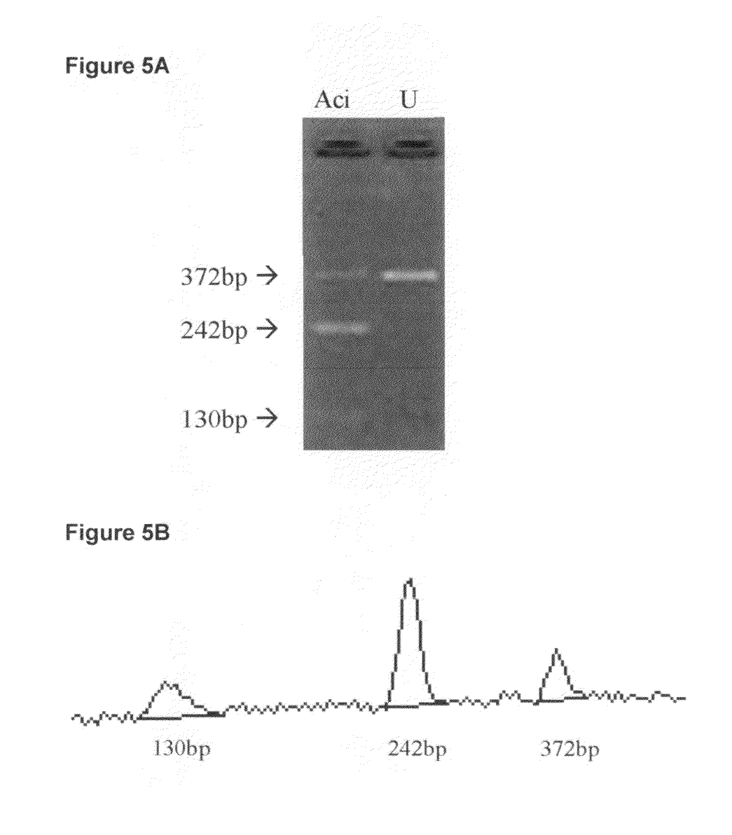

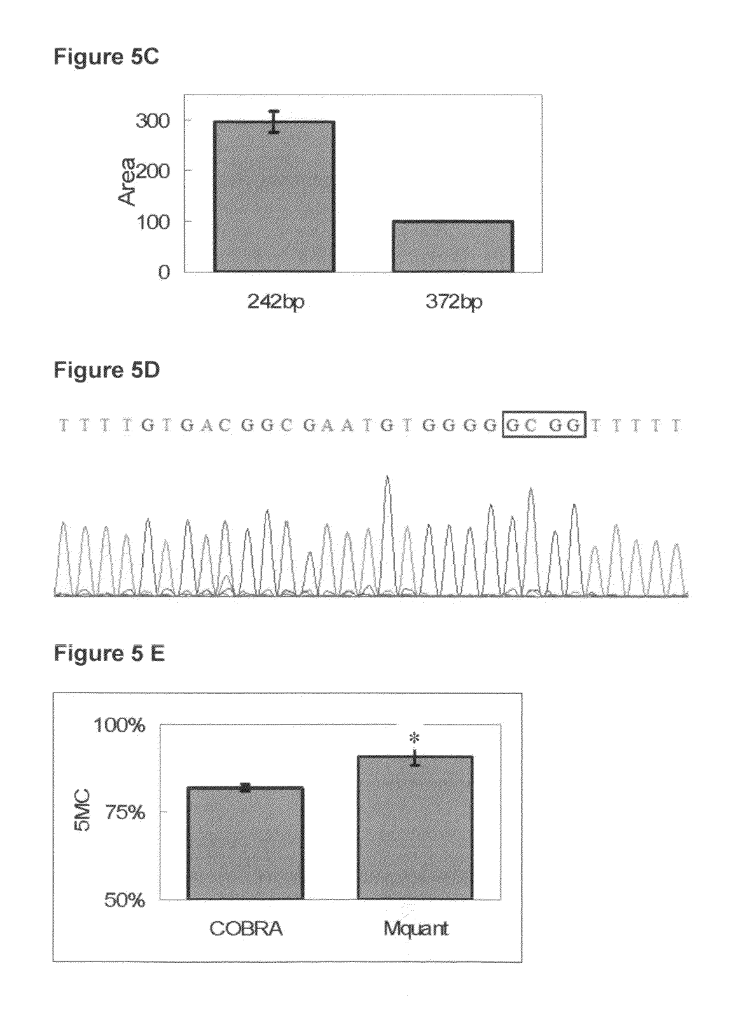

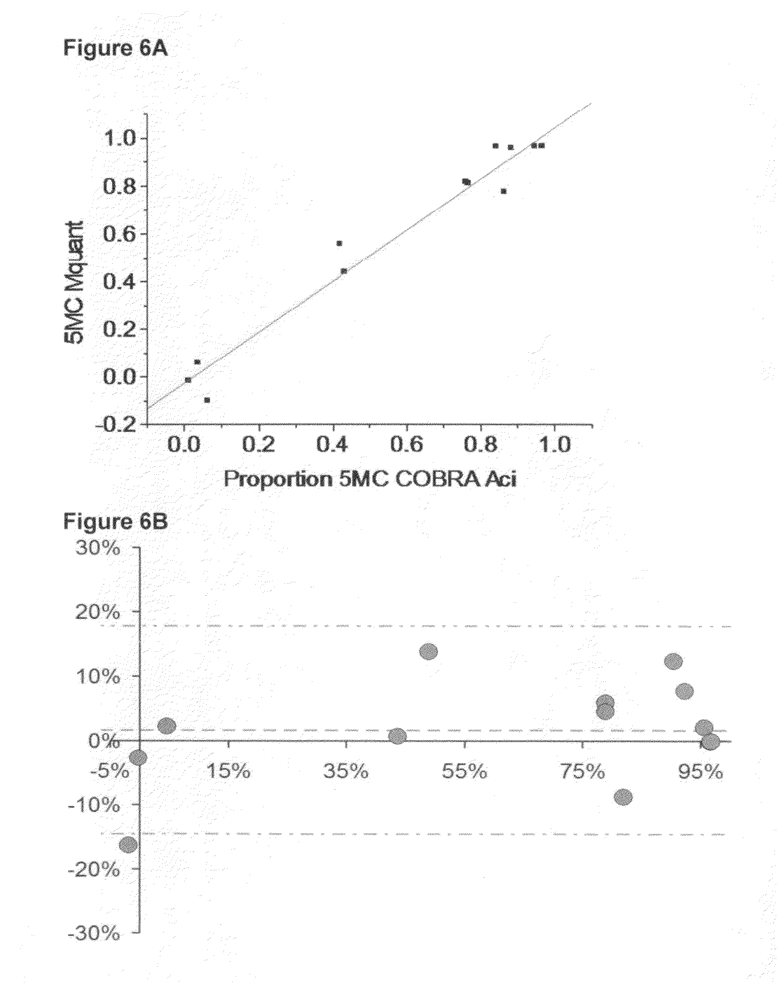

FIGS. 5 through 6B show analogous results for the Acil sites (GCGG). The correlation between methylation levels measured by the two methods was high (0.98). The mean (SD) difference between values measured by COBRA versus Mquant was 1.6% (8.1%), indicating little evidence for bias (P=0.48) between methods. The 95% LoA's were (−14.6%, +17.8%) for the GCGG site. The mean values of percent methylation for COBRA and Mquant were 61% and 63% respectively. Overall, these results show that the two methods tend to agree well at the Acil site.

Inventor made estimates of C to T conversion levels and general noise levels in the electropherograms. First, Inventor measured the C level under Ts from nonCpG Cs. These levels were small and indicated a conversion rate of >93% to 97%. Next, Inventor measured the levels of other bases (G and A) under Ts from nonCpG Cs. Levels of G and A were similar to those of C indicating that a substantial amount of C level may come from sequencing noise and not from incomplete C to T conversion. In any case, C to T conversion levels appear to be between 93 and 100%.

Inventor tested the number of Ts used to calculate T bar on the calculated DNA methylation level (data not shown) and on correlations with COBRA (Table 1). Inventor tested the use of 2 Ts (one on each side), 4 Ts (two on each side) and so on, up to 20 Ts (10 on each side). In all cases R was >0.90 and all correlations were highly significant (10-12<P<10-7). For Acil and Taqalphal sites the number of Ts between 2 and 20 had little effect on R (0.97 to 0.98 and 0.90 to 0.92 respectively). For HpyCH4IV sites R was 0.91 using 2 or 4 Ts and 0.93 to 0.95 using 8 to 20 Ts.

The data shown in FIGS. 2A, 4A and 6A is a large collection of single COBRA and Mquant determinations from a large number of amplificates. Additionally, to assess run-to-run reproducibility, ten amplificates were subsampled 3 to 5 times and assayed by both methods. The resulting data was analyzed statistically via one-way ANOVA on the parent amplificates in order to obtain the ANOVA root mean-square error (RMSE), which estimates the common standard deviation (SD) of the amplificate replications about their respective mean values. For COBRA, RMSEs were 4.3%, 1.5% and 1.0% for Hpy, Taq and Aci, respectively. For Mquant, RMSEs were 4.5%, 1.8% and 1.6% for Hpy, Taq and Aci, respectively. For the three sites combined, COBRA RMSE was 2.7% and Mquant RMSE was 3.0%. These estimates of SD are low for most methylation levels. For example, an SD of 3.0% is reasonable for a measured methylation level of 90%, 50% or even 20%. Only when methylation levels were very low (e.g. less than 10%) was the SD a substantial proportion of the measured methylation level. Overall, SDs were low, indicating that each method is highly reproducible.

Both methods measured the midrange as well as extremes of methylation. On the three sites studied by both COBRA and Mquant, in vitro methylated DNA gave 90 to 100% methylation by both methods. Mquant measures of methylation in 9 CpGs in the Avy allele of in vitro methylated DNA gave values from 90 to 98% with an average of 95%+/−2%. On the other extreme, Inventor observed nine instances of CpG sites with less than 10% methylation by both COBRA and Mquant.

TABLE 1
The Effects of T Numbers on Correlations and
P values when Mquant is Compared with COBRA.

| | 2T | 4T | 6T | 8 to 20T |
|---|---|---|---|---|
| HpyCH4IV | | | | |
| R | 0.91 | 0.91 | 0.92 | 0.93 to 0.95 |
| P | 2.6 × 10−8 | 2.9 × 10−8 | 1.0 × 10−8 | <2 × 10−9 |
| Taqalpha1 | | | | |
| R | 0.90 | 0.91 | 0.92 | 0.91 to 0.92 |
| P | 1.6 × 10−11 | 1.0 × 10−11 | 2.2 × 10−12 | <8 × 10−12 |
| Acil | | | | |
| R | 0.97 | 0.97 | 0.97 | 0.98 |
| P | 2.2 × 10−8 | 5.2 × 10−8 | 1.6 × 10−8 | <6 × 10−9 |

### Example 4

Mquant also works if an odd number of Ts are used and/or if the number of Ts used are based on which are closest rather than an equal number on each side. For example, in a case where 10 Ts arranged 5 on each side give a percent methylation of 92.5 using instead the first (closest) 5 Ts gave 92.7%, the first (closest) 6 Ts gave 92.7%, and the first (closest) 10 Ts gave 92.5%. In these, 5 Ts were 3 upstream and 2 downstream, 6 Ts were 4 upstream and 2 downstream, and 10 Ts were 6 upstream and 4 downstream.

In another example, where 10 Ts arranged 5 on each side give a percent methylation of −1.3% using instead the first (closest) 5 Ts gave −3.2%, the first (closest) 6 Ts gave −0.8%, the first (closest) 9 Ts gave −0.1%, the first (closest) 10 Ts gave −3.0%, the first (closest) 15 Ts gave −6.5%, and the first (closest) 16 Ts gave −5.8%. In these, the arrangements of Ts upstream and downstream were asymmetrical.

In another example, where 10 Ts arranged 5 on each side give a percent methylation of 33.0% using instead the first (closest) 5 Ts gave 36.3%, the first (closest) 6 Ts gave −38.0%, the first (closest) 9 Ts gave 32.3%, and the first (closest) 10 Ts gave 31.4%. In these, the arrangements of Ts upstream and downstream were asymmetrical.

### Example 5

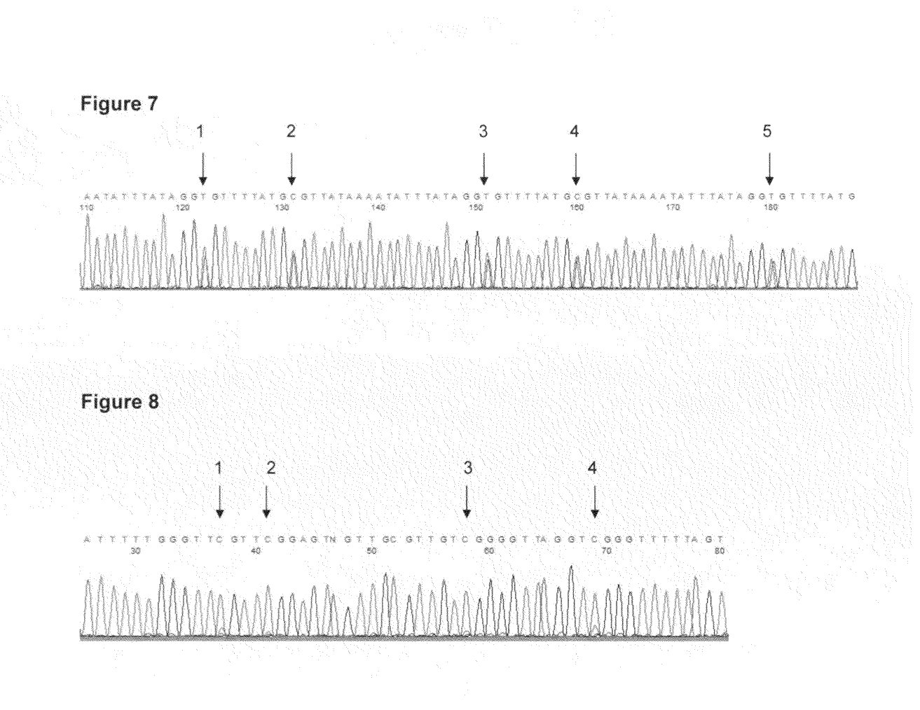

This method was applied to several mouse sequences and several human sequences. One example of each and their quantification are shown in FIGS. 7 and 8 and Tables 2 and 3. FIG. 7 deals with mouse PEG 10 gene sequence (SEQ ID No 10). FIG. 8 shows human TERT gene sequence (SEQ ID No 17).

An electropherogram of bisulfite treated and PCR amplified mouse Peg 10 gene (47) is shown in FIG. 7. This gene is imprinted and has intermediate levels of methylation on many CpG sites. Peg 10 primers were forward: 5′-GTAAAGTGATTGGTTTTGTATTTTTAAGTG-3′ (SEQ ID No 3) and reverse: 5′-TTAATTACTCTCCTACAACTTTCCAAATT-3′ (SEQ ID No 4).

TABLE 2
Proportion of DNA methylation (MethylC) on Peg10
sites in FIG. 7

| | | Proportion |
|---|---|---|
| No. Position | Sequence | MethylC |
| (1) 122 | TATAGGCGTTTT | 0.21 |
| | (SEQ ID No. 5) | |
| (2) 131 | TTTATGCGTTAT | 0.33 |
| | (SEQ ID No 6) | |
| (3) 151 | TATAGGCGTTTT | 0.22 |
| | (SEQ ID No 7) | |
| (4) 160 | TTTATGCGTTAT | 0.35 |
| | (SEQ ID No 8) | |
| (5) 180 | TATAGGCGTTTT | 0.36 |
| | (SEQ ID No 9) | |

Table 2 shows data related to the quantification of methylation on the Peg10 gene as shown in FIG. 7. In particular the column labeled Proportion MethylC shows the proportion of methylation on sites and the column labeled Sequence gives the sequence context in FIG. 7 used to locate the methylated CpG site.

An electropherogram of bisulfite treated and PCR amplified human telomerase reverse transcriptase gene (TERT) (48) is shown in FIG. 8. In some cell types the gene has high levels of methylation on multiple CpG sites. TERT primers used were: forward, 5′-GTTTTTGTATTTTGGGAG-3′ (SEQ ID No 11) and reverse, 5′-AATCCACTAAAAACCC-3′ (SEQ ID No 12).

TABLE 3
Proportion of DNA methylation (MethylC) on four
TERT CpG sites in FIG. 8

| | | Proportion |
|---|---|---|
| No. Position | Sequence | MethylC |
| (1) 37 | TGGGTTCGTTCG | 0.82 |
| | (SEQ ID No 13) | |
| (2) 41 | TTCGTTCGGAGT | 0.91 |
| | (SEQ ID No 14) | |
| (3) 58 | CGTTGTCGGGGT | 0.85 |
| | (SEQ ID No 15) | |
| (4) 69 | TTAGGTCGGGTT | 0.73 |
| | (SEQ ID No 16) | |

Table 3 shows data related to the quantification of four sites of methylation on the human TERT gene as shown in FIG. 8. In particular, the column labeled Proportion MethylC shows the proportion of methylation on sites and the column labeled Sequence gives the sequence context in FIG. 8 used to locate each methylated CpG site.

### Discussion

The above mentioned examples define a new method to quantify DNA methylation from BGS four-dye-trace electropherograms. This method uses data from the thymine trace almost exclusively and thus avoids any complications due to independent normalization of A, G, C and T peaks in four-dye-trace electropherograms (26). This method uses available, established software to read electropherograms (Phred and Bioedit).

Inventor's method analyzes sites independently and uses the same number of non-CpG Ts on either side of the analyzed site. Inventor first attempted a similar quantification using a mean of most or all non-CpG Ts in electropherograms, but this gave poor results, and simple inspection of the numbers in the Phred output revealed that the mean was less than most of the non-CpG Ts early in the electropherogram and that the mean was greater than nearly all of the non-CpG T's late in the electropherogram (data not shown). The areas (and heights) of thymine peaks gradually decline over most electropherograms and this is likely responsible for this effect. By taking the same number of Ts on either side of the analyzed CpG an effect of this gradual peak area decline over the electropherogram is obviated. The peak areas (and heights) also vary locally so that it is important to average two or more to get a value for 100% T. Fitting methods such as linear regression on neighboring T peaks could probably be used with similar effect.

Any CpG site can have between 0 and 100% methylation. In the TCGA (Taqalphal) site COBRA and Mquant differences are statistically significant yet the mean values are still within 10% methylation of each other. One possible explanation involves consistent differences readily observed in T peak areas and heights in electropherograms. Certain patterns, such as three successive Ts in a particular part of a sequence showing a gradual decline in height, are reproducible in multiple sequencings. This indicates that if a particular T derived from the C of a CpG is consistently above average height (and area) in its region of the sequence, the average methylation level measured by Mquant will be low. Similarly, if the particular T were consistently below average height (and area) in its region the average methylation level measured by Mquant would be high. Fortunately, differences that may be attributable to this effect at the Taqalphal site are small. The ACGT (HpyCH4IV) site gave nearly identical mean methylation values by COBRA and Mquant as did the GCGG (Acil) site. These mean values were within 2% methylation of each other.

Inventor agrees with other groups (22, 26) that BGS probably has limitations to quantification due to incomplete C-to-U conversion and imperfect specificity for only unmethylated C's. However, Inventor finds good agreement with the established COBRA method when Inventor quantifies methylation in bisulfite electropherograms by averaging T's on both sides of the target CpG and subtracting the T signal at the CpG site from this average T. To measure very high levels of methylation, e.g. 90% to 100%, it is necessary that the signal-to-noise ratio be very high, so that the average nonCpG T value is high and the noise at the CpG site is very low. For example, a noise level of 10% in the T trace at a CpG site leaves the maximum methylation detectable at 90% even if the DNA is actually 100% methylated. Inventor made estimates of likely conversion levels and finds them to be high (93 to 100%). Noise levels in sequencing and PCR may be higher than C signals due to incomplete C to T conversion.

Because it relies on nearby Ts to calculate methylation levels at CpGs, the Mquant method may not work as well in parts of some dense CpG islands, such as those of tumor suppressor genes, where there are few (or no) nearby Ts. In contrast, COBRA and some other methods would not be expected to show effects of nearby T density and thus COBRA may be a method of choice for such sequences. Mquant also relies on a high bisulfite conversion level and high quality sequencing traces which may not always be available. For example, the algorithm of Lewin et al. (26) corrects for bisulfite conversion levels and aligns sequences and thus can work with sequencing traces that may not be useful with Mquant.

Mquant has several advantages over COBRA. Mquant quantifies methylation on multiple independent CpG sites from analysis of a single sequencing run In contrast, COBRA usually analyzes the methylation of just one CpG site at a time. In most sequences only a minority of CpG sites are part of a restriction site as required for COBRA analysis. Mquant is amenable to robotic or manual high throughput methods. For example, most or all of the steps could be done in a 96 well format up until the sequencing capillary electrophoresis which is also available in a 96 capillary format. In contrast, COBRA is generally done by gel electrophoresis with manual imaging and analysis of gels. These COBRA methods are laborious and, on average, probably less reliable than automated sequencing by capillary electrophoresis and fluorescent dye detection. Mquant also uses less than half of the DNA needed for one COBRA analysis.

Mquant works well over the entire range of methylation levels making it suitable for analyse associated with imprinting. Inventor obtained good overall correlations between Mquant and COBRA including levels near 0% and 100% methylation. Mquant and COBRA both gave high methylation levels (90 to 98%) with in vitro methylated DNA. There are always trace values for all four bases (including T) in electropherograms and there is always background noise in COBRA gel scans. Thus no measures gave a value of 100%.

Inventor's use of the thymine trace data to quantify methylation has similarities to the method of Dikow et al. (22), but also differs in several ways. Like Mquant the Dikow algorithm can quantify from just the T trace values. However, the Dikow algorithm uses all Ts in a region without a way of choosing those well suited to quantify at a particular CpG site. In other words, they choose one set of Ts for quantification at multiple CpG sites whereas Mquant uses sets of Ts tailored to each CpG site. In Mquant each CpG uses a different set of Ts from every other CpG (unless two or more CpGs happen to have no Ts between them). Dikow et al. read electropherograms with Applied Biosystems Genescan software, whereas Inventor used Phred and Bioedit. Dikow et al. report their maximum mean signal to be just over 80% methylation in DNA where they measured nearly 100% methylation by their established methylation-specific multiplex ligation-dependent probe amplification (MS-MLPA) method. As discussed above, inventor is able to read methylation levels of 90 to 98% from in vitro methylated DNA.

Lewin et al. (26) use both the C and T trace values in a sophisticated but complex algorithm that ultimately normalizes the C and T traces to each other. They then use both the C and T trace data to calculate the level of methylation at each CpG. The Lewin algorithm also corrects for bisulfite conversion levels and aligns sequences. In contrast, Mquant quantifies methylation levels using only the T trace and thus does not require normalization or alignment. However, Inventor mainly uses sequences that are well aligned and that have high bisulfite conversion levels. The Lewin algorithm correction and alignment features allow it to use sequences that Inventor might reject for Mquant.

Inventor tested the Mquant method using different numbers of surrounding nontarget Ts (2 to 20) on either side of the target T/CpG. Inventor found few differences, although correlations with COBRA were slightly higher when using a larger number of Ts (6 to 20).

Most methods to quantify methylation target only a few sites, require laborious, specialized laboratory techniques, or require highly specialized instrumentation. Inventor used a specialized laboratory technique, COBRA, on three short sequences to show a very high correlation with the Mquant method. This method uses widely available techniques and instrumentation and should be useful in many laboratories to quantify DNA methylation levels.

While the present invention has now been described in terms of certain preferred embodiments, and exemplified with respect thereto, one skilled in the art will readily appreciate that various modifications, changes, omissions and substitutions may be made without departing from the spirit thereof. It is intended, therefore, that the present invention be limited solely by the scope of the following claims.

### REFERENCES

1. Waddington C H: The epigenotype. Endeavour 1942, 1:18-20
2. Hotchkiss R D: The quantitative separation of purines, pyrimidines, and nucleosides by paper chromatography. J Biol Chem 1948, 175:315-332
3. Bird A: The essentials of DNA methylation. Cell 1992, 70:5-8
4. Feinberg A P: The epigenetics of cancer etiology. Semin Cancer Biol 2004, 14:427-432
5. Murrell A, Rakyan V K, Beck S: From genome to epigenome. Hum Mol Genet 2005, 14:R3-R10
6. Fuks F: DNA methylation and histone modifications: teaming up to silence genes. Curr Opin Genet Dev 2005, 15:490-495
7. Rodenhiser O, Mann M: Epigenetics and human disease: translating basic biology into clinical applications. Can Med Assoc J 2006, 174:341-348
8. Jiang Y H, Bressler J, Beaudet A L: Epigenetics and human disease. Annu Rev Genomics Hum Genet 2004, 5:479-510
9. Novik K L, Nimmrich I, Genc B, Maier S, Piepenbrock C, Olek A, Beck S: Epigenomics: genome-wide study of methylation phenomena. Curr Issues Mol Biol 2002, 4:111-128
10. Ogino S, Kawasaki T, Brahmandam M, Cantor M, Kirkner G J, Spiegelman D, Makrigiorgos G M, Weisenberger D J, Laird P W, Loda M, Fuchs C S: Precision and performance characteristics of sodium bisulfite conversion and real-time PCR (MethyLight) for quantitative DNA methylation analysis. J Mol Diagn 2006, 8:209-217
11. Cooney, C. A. (2007) Epigenetics—DNA-based mirror of our environment? Dis. Markers, 23, 121-137.
12. Jones, P. A. and Baylin, S. B. (2007) The epigenomics of cancer. Cell, 128, 683-692.
13. Liu, L., van, G. T., Kadish, I. and Tollefsbol, T. O. (2007) DNA methylation impacts on learning and memory in aging Neurobiol. Aging. September 10
14. Ptak, C. and Petronis, A. (2007) Epigenetics and Complex Disease: From Etiology to New Therapeutics Annu. Rev. Pharmacol. Toxicol. September 17
15. Robertson, K. D. (2005) DNA methylation and human disease. Nat. Rev. Genet., 6, 597-610.
16. Siegmund, K. D., Connor, C. M., Campan, M., Long, T. I., Weisenberger, D. J., Biniszkiewicz, D., Jaenisch, R., Laird, P. W. and Akbarian, S. (2007) DNA methylation in the human cerebral cortex is dynamically regulated throughout the life span and involves differentiated neurons. PLoS. ONE., 2, e895.
17. Szyf, M., Weaver, I. and Meaney, M. (2007) Maternal care, the epigenome and phenotypic differences in behavior. Reprod. Toxicol., 24, 9-19.
18. van, V. J., Oates, N. A. and Whitelaw, E. (2007) Epigenetic mechanisms in the context of complex diseases. Cell Mol Life Sci., 64, 1531-1538.
19. Clark, S. J., Harrison, J., Paul, C. L. and Frommer, M. (1994) High sensitivity mapping of methylated cytosines. Nucleic Acids Res., 22, 2990-2997.
20. Colella, S., Shen, L., Baggerly, K. A., Tssa, J. P. and Krahe, R. (2003) Sensitive and quantitative universal Pyrosequencing methylation analysis of CpG sites. Biotechniques, 35, 146-150.
21. Cooney, C. A., Eykholt, R. L. and Bradbury, E. M. (1988) Methylation is coordinated on the putative replication origins of Physarum ribosomal DNA. J. Mol. Biol., 204, 889-901.
22. Dikow, N., Nygren, A. O., Schouten, J. P., Hartmann, C., Kramer, N., Janssen, B. and Zschocke, J. (2007) Quantification of the methylation status of the PWS/AS imprinted region: comparison of two approaches based on bisulfite sequencing and methylation-sensitive MLPA. Mol. Cell Probes, 21, 208-215.
23. Dolinoy, D. C., Weidman, J. R., Waterland, R. A. and Jirtle, R. L. (2006) Maternal genistein alters coat color and protects Avy mouse offspring from obesity by modifying the fetal epigenome. Environ. Health Perspect., 114, 567-572.
24. Kaminsky, Z. A., Assadzadeh, A., Flanagan, J. and Petronis, A. (2005) Single nucleotide extension technology for quantitative site-specific evaluation of metC/C in GC-rich regions Nucleic Acids Res., 33, e95.
25. Kurmasheva, R. T., Peterson, C. A., Parham, D. M., Chen, B., McDonald, R. E. and Cooney, C. A. (2005) Upstream CpG island methylation of the PAX3 gene in human rhabdomyosarcomas. Pediatr. Blood Cancer, 44, 328-337.
26. Lewin, J., Schmitt, A. O., Adorjan, P., Hildmann, T. and Piepenbrock, C. (2004) Quantitative DNA methylation analysis based on four-dye trace data from direct sequencing of PCR amplificates. Bioinformatics., 20, 3005-3012.
27. Nygren, A. O., Ameziane, N., Duarte, H. M., Vijzelaar, R. N., Waisfisz, Q., Hess, C. J., Schouten, J. P. and Errami, A. (2005) Methylation-specific MLPA (MS-MLPA): simultaneous detection of CpG methylation and copy number changes of up to 40 sequences. Nucleic Acids Res., 33, e128.
28. Pfeifer, G. P. and Riggs, A. D. (1996) Genomic sequencing by ligation-mediated PCR. Mol. Biotechnol., 5, 281-288.
29. Tost, J., Dunker, J. and Gut, I. G. (2003) Analysis and quantification of multiple methylation variable positions in CpG islands by Pyrosequencing. Biotechniques, 35, 152-156.
30. Uhlmann, K., Brinckmann, A., Toliat, M. R., Ritter, H. and Nurnberg, P. (2002) Evaluation of a potential epigenetic biomarker by quantitative methyl-single nucleotide polymorphism analysis. Electrophoresis, 23, 4072-4079.
31. Wong, I. H. (2006) Qualitative and quantitative polymerase chain reaction-based methods for DNA methylation analyses. Methods Mol. Biol., 336, 33-43.
32. Xiong, Z. and Laird, P. W. (1997) COBRA: a sensitive and quantitative DNA methylation assay. Nucleic Acids Res., 25, 2532-2534.
33. Yang, A. S., Estecio, M. R., Doshi, K., Kondo, Y., Tajara, E. H. and Issa, J. P. (2004) A simple method for estimating global DNA methylation using bisulfite PCR of repetitive DNA elements. Nucleic Acids Res., 32, e38.
34. Clark, S. J., Statham, A., Stirzaker, C., Molloy, P. L. and Frommer, M. (2006) DNA methylation: bisulphite modification and analysis. Nat. Protoc., 1, 2353-2364.
35. Carr, I. M., Valleley, E. M., Cordery, S. F., Markham, A. F. and Bonthron, D. T. (2007) Sequence analysis and editing for bisulphite genomic sequencing projects Nucleic Acids Res., 35, e79.
36. Davis, T. L., Trasler, J. M., Moss, S. B., Yang, G. J. and Bartolomei, M. S. (1999) Acquisition of the H19 methylation imprint occurs differentially on the parental alleles during spermatogenesis. Genomics, 58, 18-28.
37. Lucifero, D., Mertineit, C., Clarke, H. J., Bestor, T. H. and Trasler, J. M. (2002) Methylation dynamics of imprinted genes in mouse germ cells. Genomics, 79, 530-538.
38. Cooney, C. A., Dave, A. A. and Wolff, G. L. (2002) Maternal methyl supplements in mice affect epigenetic variation and DNA methylation of offspring. J. Nutr., 132, 2393S-2400S.
39. Rakyan, V. K., Chong, S., Champ, M. E., Cuthbert, P. C., Morgan, H. D., Luu, K. V. K. and Whitelaw, E. (2003) Transgenerational inheritance of epigenetic states at the murine AxinFu allele occurs after maternal and paternal transmission. Proc. Natl. Acad. Sci. U.S.A, 100, 2538-2543.
40. Li, L. C. and Dahiya, R. (2002) MethPrimer: designing primers for methylation PCRs. Bioinformatics., 18, 1427-1431.
41. Rudi, K., Rud, I. and Holck, A. (2003) A novel multiplex quantitative DNA array based PCR (MQDA-PCR) for quantification of transgenic maize in food and feed. Nucleic Acids Res., 31, e62.
42. Ewing, B., Hillier, L., Wendl, M. C. and Green, P. (1998) Base-calling of automated sequencer traces using phred. I. Accuracy assessment. Genome Res., 8, 175-185.
43. Ewing, B. and Green, P. (1998) Base-calling of automated sequencer traces using phred. II. Error probabilities. Genome Res., 8, 186-194.
44. Bland, J. M. and Altman, D. G. (1986) Statistical methods for assessing agreement between two methods of clinical measurement. Lancet, 1, 307-310.
45. Bland, J. M. and Altman, D. G. (1999) Measuring agreement in method comparison studies. Stat. Methods Med. Res., 8, 135-160.
46. Qiu, P., Soder, G. J., Sanfiorenzo, V. J., Wang, L., Greene, J. R., Fritz, M. A. and Cai, X. Y. (2003) Quantification of single nucleotide polymorphisms by automated DNA sequencing. Biochem. Biophys. Res. Commun., 309, 331-338.
47. Ono R, Shiura H, Aburatani H, Kohda T, Kaneko-Ishino T, Ishino F. Identification of a large novel imprinted gene cluster on mouse proximal chromosome 6. Genome Res. 2003 July; 13(7):1696-705.
48. Clement G, Braunschweig R, Pasquier N, Bosman F T, Benhattar J. Methylation of APC, TIMP3, and TERT: a new predictive marker to distinguish Barrett's oesophagus patients at risk for malignant transformation. J Pathol. 2006 January; 208(1):100-7.

What is claimed is:

1. A method to quantify cytosine methylation at a particular target CpG site in DNA of a virus, cell or organism, comprising:
performing bisulfite genomic sequencing,
wherein a DNA sample extracted from a virus, cell or organism is treated with sodium bisulfite to convert cytosine to uracil;
selecting and, amplifying a fragment of this treated DNA;
sequencing the amplificate,
wherein the sequence is recorded as an electropherogram;
performing a quantitative analysis of the amplificate from the electropherogram,
wherein the area under a peak is measured in a plurality of peaks at either side of the target CpG site to determine the mean T area (T bar) surrounding the site;
subtracting the area of the T at the target CpG site from the mean T area, wherein the difference is termed delta T; and
calculating the proportional level of methylation as a quotient of delta T/T bar.

2. The method in accordance with claim 1, wherein the plurality of peaks surrounding the target CpG site number 2-20.

3. The method in accordance with claim 1, wherein Ts surrounding the target CpG site number 10 or more.

4. The method in accordance with claim 1, wherein the Ts used to calculate T bar have a T signal-to-noise ratio of 10 or better with respect to their secondary peak.

5. The method in accordance with claim 1, wherein the Ts used to calculate T bar are at least 10 times the area of their secondary base (C, G or A).

6. The method in accordance with claim 1, wherein an equal number of Ts from each side of the target CpG is used.

7. The method in accordance with claim 6, wherein the number comprises 5 on each side of the target CpG.

8. The method in accordance with claim 1, wherein the calculation is stated as 100×(delta T)/(T bar) representing the percentage of methylation.

9. In a method to quantify DNA methylation at a particular site from bisulfite genomic sequencing using data from four-dye-trace trace value electropherograms from fluorescent dye terminator sequencing, an improvement comprising:
selecting a target CpG site;
determining the mean T area (T bar) from a plurality of Ts surrounding the target CpG site;
subtracting the area of the T at the target CpG site from T bar,
wherein the subtracting yields delta T; and
calculating the level of methylation on the site as the proportion of (delta T)/(T bar).

10. The method in accordance with claim 9, wherein Ts surrounding the target CpG site number 2-20.

11. The method in accordance with claim 10, wherein Ts surrounding the target CpG site number 10 or more.

12. The method in accordance with claim 9, wherein the Ts used to calculate T bar have a T signal-to-noise ratio of 10 or better with respect to their secondary peak.

13. The method in accordance with claim 9, wherein the Ts used to calculate T bar are at least 10 times the area of their secondary base (C, G or A).

14. The method in accordance with claim 9, wherein an equal number of T's from each side of the target CpG are used.

15. The method in accordance with claim 14, wherein the number comprises 5 on each side.

16. The method in accordance with claim 9, wherein the calculation is stated as 100×(delta T)/(T bar) representing the percentage of methylation.

17. An algorithm for quantifying DNA methylation at a particular site from bisulfite genomic sequencing using data from four-dye-trace trace value electropherograms from fluorescent dye terminator sequencing, comprising:
choosing the target CpG site;
determining the mean T area (T bar) from a plurality of Ts surrounding the target CpG site.
subtracting the area of the T at the target CpG site from T bar to yield delta T (i.e. T bar−CpG T=delta T); and
calculating the level of methylation on the site as the proportion, (delta T)/(T bar).

18. The method in accordance with claim 17, wherein Ts surrounding the target CpG site number 2-20.

19. The method in accordance with claim 18, wherein Ts surrounding the target CpG site number 10 or more.

20. The method in accordance with claim 17, wherein the Ts used to calculate T bar have a T signal-to-noise ratio of 10 or better with respect to their secondary peak.

21. The method in accordance with claim 17, wherein the Ts used to calculate T bar are at least 10 times the area of their secondary base (C, G or A).

22. The method in accordance with claim 18, wherein an equal number of T's from each side of the target CpG are used.

23. The method in accordance with claim 22, wherein the number comprises 5 on each side.

24. The method in accordance with claim 9, wherein the calculation is stated as 100×(delta T)/(T bar) representing the percentage of methylation.

25. An algorithm for quantifying DNA methylation at a particular site from bisulfite genomic sequencing using data from four-dye-trace trace value electropherograms from fluorescent dye terminator sequencing, comprising:
choosing the target CpG site;
determining the mean T area (T bar) from 10 Ts surrounding the target CpG site
wherein Ts used to calculate T bar are at least 10 times the area of their secondary base (C, G or A),
wherein the Ts used to calculate T bar have a T signal-to-noise ratio of 10 or better with respect to their secondary peak, and
wherein an equal number of T's from each side of the target CpG (i.e. 5 on each side) are used;
subtracting the area of the T at the target CpG site from T bar to yield delta T (i.e. T bar−CpG T=delta T); and
calculating the level of methylation on the site as the proportion, (delta T)/(T bar), or the percentage, 100×(delta T)/(T bar).

26. An algorithm for quantifying the level of a nucleotide signal at a polymorphic site in a sequencing electropherogram using trace value data, comprising:
choosing the target polymorphic site and nucleotide (N1);
choosing a second nucleotide (N2) at the polymorphic site (N2p);
determining the mean area (N2 bar) from a plurality of examples of the second nucleotide surrounding the target polymorphic site;
subtracting the area of the second nucleotide at the target polymorphic site from N2 bar to yield delta N2 (i.e. N2 bar−N2p=delta N2); and
calculating the level of N1 at the polymorphic site as the proportion, (delta N2)/(N2 bar).

27. The method in accordance with claim 26, wherein N2s surrounding the target polymorphic site number 2-20.

28. The method in accordance with claim 27, wherein N2s surrounding the target polymorphic site number 10 or more.

29. The method in accordance with claim 26, wherein the N2s used to calculate N2 bar have an N2 signal-to-noise ratio of 10 or better with respect to their secondary peak.

30. The method in accordance with claim 26, wherein the N2s used to calculate N2 bar were at least 10 times the area of their secondary base.

31. The method in accordance with claim 26, wherein an equal number of N2s from each side of the target polymorphic site are used.

32. The method in accordance with claim 31, wherein the number comprises 5 on each side.

33. The method in accordance with claim 26, wherein the calculation 100×(delta N2)/(N2 bar) represents the percentage of N1 in the polymorphic site.
